(19) United States
(12) Patent Application Publication
(10) Pub. No.: US 2026/0152085 A1
(43) Pub. Date: Jun. 4, 2026

(54) SYSTEM AND METHOD OF INDICATING CAPACITY OF POWER DELIVERY SEGMENT OF ELECTRIC POWER SUPPLY SYSTEM

(71) Applicant: Caterpillar Inc., Peoria, IL (US)

(72) Inventor: Mahendra S. Waldia, Oro Valley, AZ (US)

(73) Assignee: Caterpillar Inc., Peoria, IL (US)

(21) Appl. No.: 18/966,210

(22) Filed: Dec. 3, 2024

(51) Int. Cl. B60L 53/63; B60L 53/30

(52) U.S. Cl. CPC B60L 53/63; B60L 53/305; B60L 2200/44

(57) ABSTRACT

A capacity indication system is associated with an electric power supply system that includes one or more power delivery segments adapted to provide power to a predetermined number of work machines operating at a worksite. The capacity indication system includes a controller including one or more memories and one or more processors. The one or more processors are configured to receive, from the one or more memories, information pertaining to a threshold power level that is required at the one or more power delivery segments to meet power requirements of the predetermined number of work machines, determine an available power at the one or more power delivery segments, compare the available power with the threshold power level, and generate an output signal to indicate insufficiency of the available power at the one or more power delivery segments if the available power is lesser than the threshold power level.

### TECHNICAL FIELD

The present disclosure relates to a capacity indication system associated with an electric power supply system and a method of indicating capacity of at least one power delivery segment of the electric power supply system.

### BACKGROUND

Work machines, such as mining trucks, loaders, dozers, or other construction or mining equipment, are implemented with diesel-electric systems or battery systems to provide operating power to such work machines. It is desirable to have a high uptime for these work machines. Thus, a worksite, such as a mining site, includes an electric power supply system. The electric power supply system may include, for example, a dynamic energy transfer system or an overhead trolley line system. The electric power supply system includes multiple power segments. The work machines may be connected to any one of the power segments to provide a power supply to the work machine.

Further, each power segment may be designed to provide power to a predetermined number of work machines at a given time instant. A capacity of each power segment may be sized according to the number of work machines that can be connected to the power segment at a given time instant. If a greater number of work machines connect to a particular power segment than its designed capacity, the power segment may experience a low voltage situation, may affect a speed of at which power is supplied to the work machines that are already connected to the power segment, or an outage/overload situation, which is not desirable. Such conditions may impact a power delivery capability of the power segment and may sometime lead to failure of the power segment, thereby affecting an operational efficiency at worksites.

U.S. Patent Application 2023/0391225 describes an electric machine, a sitewide control system, and a method that uses a trolley power system at a worksite. The trolley power system allows electric machines at the worksite to draw power from the trolley power system to concurrently operate to perform tasks and recharge their batteries. This allows the batteries on electric machines to be smaller than they would otherwise be, since a fully charged battery is not needed when operational power can be drawn from the trolley power system. The trolley power system is segmented, such that if one segment is faulted, the other segments can operate to provide power to electric machines at the worksite. Additionally, a sitewide controller initiates operational changes, such as a change in speed, for the electric machines at the worksite to compensate for one or more faulted segments.

### SUMMARY OF THE DISCLOSURE

In an aspect of the present disclosure, a capacity indication system associated with an electric power supply system is provided. The electric power supply system includes at least one power delivery segment disposed at a worksite. The at least one power delivery segment is adapted to provide electric power to a predetermined number of work machines operating at the worksite. The capacity indication system includes a controller including one or more memories and one or more processors communicably coupled to the one or more memories. The one or more processors are configured to receive, from the one or more memories, information pertaining to a threshold power level that is required at the at least one power delivery segment to meet electric power requirements of the predetermined number of work machines. The one or more processors are also configured to determine an available power at the at least one power delivery segment. The one or more processors are further configured to compare the available power at the at least one power delivery segment with the threshold power level. The one or more processors are configured to generate an output signal if the available power at the at least one power delivery segment is lesser than the threshold power level. The output signal is adapted to indicate operators of one or more work machines operating at the worksite regarding an insufficiency of the available power at the at least one power delivery segment.

In another aspect of the present disclosure, a method of indicating capacity of at least one power delivery segment of an electric power supply system is provided. The at least one power delivery segment is adapted to provide electric power to a predetermined number of work machines operating at a worksite. The method includes receiving, by one or more processors of a controller, information pertaining to a threshold power level that is required at the at least one power delivery segment to meet electric power requirements of the predetermined number of work machines. The information pertaining to the threshold power level is received from one or more memories of the controller. The method also includes determining, by the one or more processors, an available power at the at least one power delivery segment. The method further includes comparing, by the one or more processors, the available power at the at least one power delivery segment with the threshold power level. The method includes generating, by the one or more processors, an output signal if the available power at the at least one power delivery segment is lesser than the threshold power level. The output signal is adapted to indicate operators of one or more work machines operating at the worksite regarding an insufficiency of the available power at the at least one power delivery segment.

Other features and aspects of this disclosure will be apparent from the following description and the accompanying drawings.

### BRIEF DESCRIPTION OF THE DRAWINGS

FIG. 1 is a schematic illustration of a worksite with two work machines and an electric power supply system, according to an example of the present disclosure;

FIG. 2 is a schematic illustration of the worksite with one work machine and an electric power supply system, according to another example of the present disclosure;

FIG. 3 is a block diagram for a capacity indication system associated with the electric power supply systems of FIGS. 1 and 2, according to an example of the present disclosure;

FIG. 4 is a block diagram for a capacity indication system associated with the electric power supply systems of FIGS. 1 and 2, according to another example of the present disclosure;

FIG. 5 is a block diagram for a capacity indication system associated with the electric power supply systems of FIGS. 1 and 2, according to yet another example of the present disclosure; and

FIG. 6 is a flowchart for a method of indicating capacity of at least one power delivery segment of the electric power supply systems of FIGS. 1 and 2, according to an example of the present disclosure.

### DETAILED DESCRIPTION

Wherever possible, the same reference numbers will be used throughout the drawings to refer to the same or like parts.

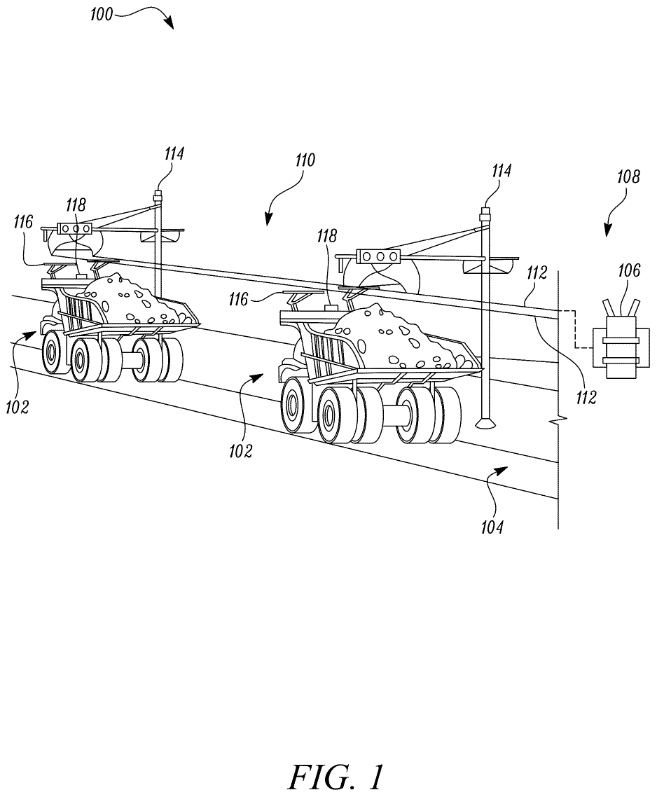

Referring to FIG. 1, a schematic illustration of an exemplary worksite 100 and two work machines 102 is shown. Only two work machines 102 are shown in FIG. 1 as an example. Alternatively, any number of work machines 102 may operate at the worksite 100. The work machines 102 may be a mining truck, a loader, a dozer, a dump truck, a skid loader, an excavator, a backhoe, a combine, a crane, a drilling equipment, a trencher, a tractor, or any suitable work machine. The work machines 102 are embodied as mining trucks herein. The work machines 102 as depicted travel on ground 104. The work machines 102 may be an autonomous work machine, a semi-autonomous work machine, or a manually operated work machine. The work machines 102 may be of similar type or may be different from each other.

The worksite 100 includes an electric power supply system 108. The electric power supply system 108 supplies electric power to diesel electric work machines, battery-operated work machines, hybrid work machines, or any other mobile equipment known to persons in the art.

In one example, some work machines 102 may include diesel electric work machines. Specifically, such work machines 102 may include a diesel engine (not shown) to provide operating power to the corresponding work machine 102 and may also receive a power supply via external power, such as power supplied by the electric power supply system 108. In such instances, the work machines 102 may transition between being powered via the onboard diesel engine and the electric power supply system 108. In another example, some work machines 102 may include battery-operated work machines. Specifically, such work machines 102 may include a battery system (not shown) to provide operating power to the corresponding work machine 102. Some of the work machines 102 may also embody hybrid work machines or any other type of work machine that can draw power from the electric power supply system 108.

The work machine 102 receives electric power from the electric power supply system 108 disposed at the worksite 100. In case of diesel electric work machines, power supplied by the electric power supply system 108 may be directly used to operate the work machine 102. Further, in case of battery-operated work machines, power supplied by the electric power supply system 108 may either be directly used to operate the work machine 102 or to charge the onboard battery system.

The electric power supply system 108 may be an overhead trolley system or a dynamic energy transfer system. The electric power supply system 108, as illustrated in FIG. 1, is the overhead trolley line system. The electric power supply system 108 includes a number of substations 106. Only one substation 106 is illustrated in FIG. 1 as an example. The substation 106 may receive power from any suitable source, such as an electric grid or from power generation facilities at the worksite 100.

The electric power supply system 108 also includes one or more power delivery segments 110 disposed at the worksite 100. Typically, the electric power supply system 108 will include a number of power delivery segments 110, although only one power delivery segment 110 is illustrated in FIG. 1. The power delivery segments 110 may be electrically separate from each other, such that if one power delivery segment 110 is rendered inoperable, other power delivery segments 110 may still provide power to the work machines 102. The power delivery segment 110 receives a power supply from a corresponding substation 106. In some examples, a total number of the power delivery segments 110 corresponds to a total number of the substations 106. In some examples, two or more power delivery segments 110 may receive power supply from the same substation 106. For example, some power delivery segments 110 may receive power supply from one substation 106, while some power delivery segments 110 may receive power supply from another substation 106.

Further, the one or more power delivery segments 110 provide electric power to a predetermined number of work machines 102 operating at the worksite 100. For example, each power delivery segment 110 may provide electric power to three work machines, four work machines, or five work machines, at a given instant of time. In some examples, a capacity of each substation 106 may be sized according to a total number of the work machines 102 that may be connected to a corresponding power delivery segment 110 at a given instant of time. If a greater number of work machines 102 connect to any power delivery segment 110 than its designed capacity, the corresponding power delivery segment 110 may experience a low voltage situation, a rejection, may affect a speed at which power is supplied to the work machines 102 that are already connected to the power delivery segment 110, or may cause an outage.

Further, the power delivery segment 110, as illustrated in FIG. 1, is a trolley line. The power delivery segment 110 may provide any suitable type and/or magnitude of electrical power to the work machine 102. In some cases, the power delivery segment 110 may provide direct current (DC) power at any suitable voltage and current to the work machines 102.

The power delivery segment 110 includes one or more power lines 112, that are supported by one or more poles 114. The power lines 112 may be made of any suitable conductor, such as cables of any suitable gauge, conductance, etc.

Further, the work machine 102 includes a connector 116 that allows the work machine 102 to be electrically and/or physically connected to the power delivery segment 110 and derive electrical power therefrom. As the work machine 102 moves on the ground 104, the connector 116 may receive electric power from the power delivery segment 110.

The power lines 112 of the power delivery segment 110 are disposed overhead. However, it should be noted that the power lines 112 may be provided in any suitable configuration, in accordance with the disclosure herein. Additionally, the connector 116 may be of any suitable configuration to accommodate different configurations of the power lines 112. For example, telescopic rods, spring-biased contactors, slot connectors, and the like may be used to contact the power lines 112 and deliver electrical power to the work machine 102.

Further, the work machine 102 may communicate wirelessly, via an antenna 118, with other systems at the worksite 100. For example, the antenna 118 allows the work machine 102 to receive and/or send wireless signals from/to a sitewide control system 122. The sitewide control system 122 may include a machine dispatch system that may control a deployment of the work machines 102 or provide real-time alerts to the operators of the work machines 102. Further, the sitewide control system 122 may be any other system that is used to manage operations at the worksite 100. For example, the sitewide control system 122 may control the work machines 102 to autonomously operate the work machines 102. The sitewide control system 122 may be in communication with each work machine 102 operating at the worksite 100.

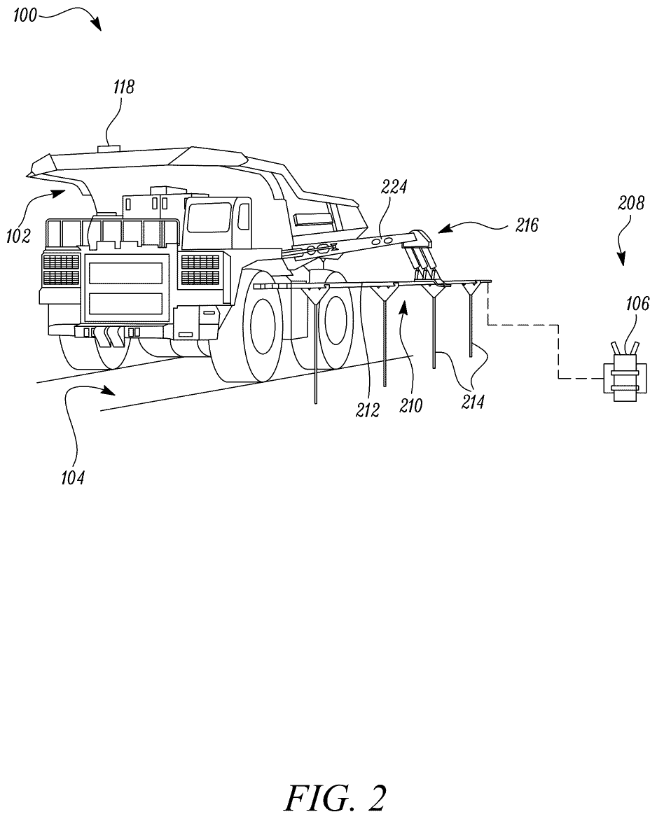

Referring to FIG. 2, a schematic illustration of the worksite 100 with one work machine 102 is shown. Only a single work machine 102 is illustrated in FIG. 2 as an example. The work machine 102 receives electric power from an electric power supply system 208 disposed at the worksite 100. The electric power supply system 208 is substantially similar to the electric power supply system 108 of FIG. 1, with common components referred to by the same numerals. However, the electric power supply system 208 includes the dynamic energy transfer system. The electric power supply system 208 includes the number of substations 106.

The electric power supply system 208 also includes one or more power delivery segments 210 disposed at the worksite 100. Further, the at least one power delivery segment 210, as illustrated in FIG. 2, is a power rail system. Typically, the electric power supply system 208 will include a number of power delivery segments 210, although only one power delivery segment 210 is illustrated in FIG. 1. The power delivery segment 210 receives a power supply from a corresponding substation 106.

Further, the one or more power delivery segments 210 provide electric power to a predetermined number of work machines 102 operating at the worksite 100. For example, each power delivery segment 210 may provide electric power to three work machines, four work machines, or five work machines, at a given instant of time. Furthermore, the power delivery segments 210 may provide any suitable type and/or magnitude of electrical power to the work machine 102. In some cases, the power delivery segment 210 may provide DC power at any suitable voltage and current.

Moreover, the power delivery segment 210 includes one or more power rails 212 supported by one or more stands 214. The one or more power rails 212 may be constructed of any suitable conductor of electricity. The power rails 212 are embodied as rigid rails herein that run along a side of the worksite 100 and are supported by the stands 214.

The work machine 102 includes the connector 216 that allows the work machine 102 to be electrically and/or physically connected to the power delivery segment 210 and derive electrical power therefrom. As the work machine 102 moves on the ground 104, the connector 216 may receive electric power from the power delivery segment 210.

The connector 216 is connected to the work machine 102 by a support arm 224. The support arm 224 is coupled to a frame of the work machine 102. The support arm 224 may be movable from a stowed position relative to the frame, to a service position as shown in FIG. 2.

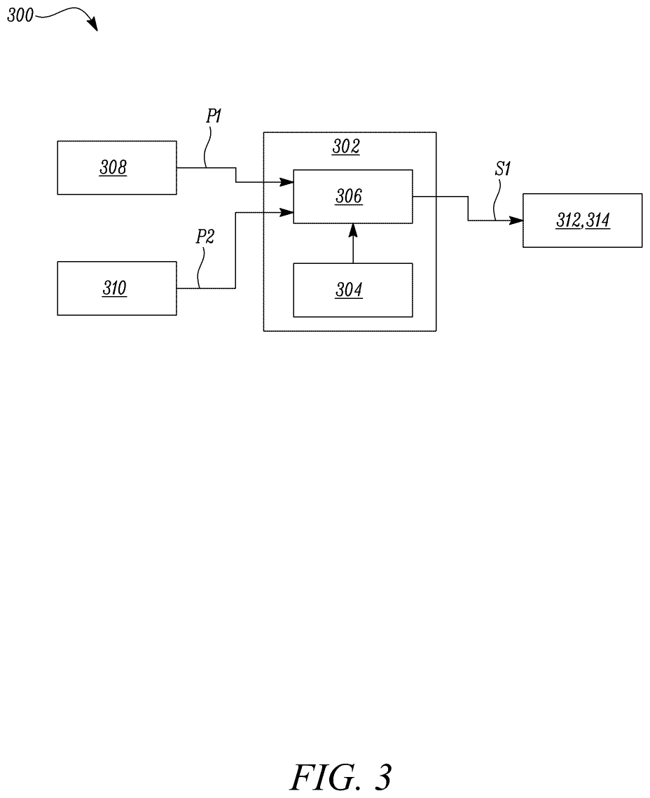

Referring to FIG. 3, a block diagram for a capacity indication system 300 is provided. The capacity indication system 300 is associated with the electric power supply systems 108, 208 (see FIGS. 1 and 2). For explanatory purpose, the capacity indication system 300 will now be discussed corresponding to the electric power supply system 108. The capacity indication system 300 includes a controller 302. The controller 302 may be present at a back-office, at the substation 106, or at any other location, without any limitations. The controller 302 includes one or more memories 304 and one or more processors 306 communicably coupled to the one or more memories 304. The one or more memories 304 stores information pertaining to a threshold power level that is required at the one or more power delivery segments 110 (see FIG. 1) to meet electric power requirements of the predetermined number of work machines 102. The one or more memories 304 may be any volatile or non-volatile computer memory.

Further, the one or more processors 306 may be any kind of hardware-based electronic device with data processing capabilities including, by way of non-limiting example a digital processing device, such as, digital signal processor (DSP), a microcontroller, a field programmable circuit, an application-specific integrated circuit (ASIC), etc., or any device which includes or is operatively connected to one or more processing devices, or an analog circuit implementing control logic.

The one or more processors 306 receive, from the one or more memories 304, the information pertaining to the threshold power level that is required at the one or more power delivery segments 110 to meet electric power requirements of the predetermined number of work machines 102. Further, the one or more processors 306 determine an available power at the one or more power delivery segments 110. The one or more processors 306 determine the available power at the one or more power delivery segments 110 based on inputs from one or more sensors 308 and/or a segment controller 310.

Specifically, in one example, the capacity indication system 300 includes the one or more sensors 308 disposed at the one or more power delivery segments 110. In some examples, the one or more sensors 308 may be disposed between the substation 106 and the power delivery segment 110, or at an outlet of the substation 106. The one or more sensors 308 generate an input signal P1 pertaining to the available power at the one or more power delivery segments 110. The one or more processors 306 receive the input signal P1 from the one or more sensors 308 to determine the available power at the one or more power delivery segments 110. The one or more sensors 308 includes a current sensor, a voltage sensor, and/or a combination thereof, without any limitations.

In another example, the one or more processors 306 are communicably coupled with the segment controller 310 associated with the one or more power delivery segments 110. The segment controller 310 may receive/transmit data to the substation 106 and may control the substation 106 as required. The one or more processors 306 receive an input signal P2 from the segment controller 310 to determine the available power at the one or more power delivery segments 110. In an example, the one or more processors 306 may receive an input pertaining to the available power at the one or more power delivery segments 110 via a datalink. It should be noted that the present disclosure is not limited by a technique of determining the available power at the one or more power delivery segments 110.

In some examples, the one or more processors 306 determine the available power at the one or more power delivery segments 110 based on one or more of the number of work machines 102 that are connected to the one or more power delivery segments 110, an amount of electric power that is being supplied to each of the number of work machines 102 that are connected to the one or more power delivery segments 110, and/or a type of each work machine 102 from the number of work machines 102 that are connected to the one or more power delivery segments 110. Thus, the processors 306 may determine the available power at the power delivery segment 110 based on one or more of the input signal P1, the input signal P2, the data related to the number of work machines 102 that are connected to the power delivery segment 110, the data related to the amount of electric power that is being supplied to each of the number of work machines 102 that are connected to the power delivery segment 110, and/or the data related to the type of each work machine 102 from the number of work machines 102 that are connected to the power delivery segment 110.

Further, the one or more processors 306 compare the available power at the one or more power delivery segments 110 with the threshold power level. Furthermore, the one or more processors 306 generate an output signal S1 if the available power at the one or more power delivery segments 110 is lesser than the threshold power level. The output signal S1 indicates operators of the one or more work machines 102 operating at the worksite 100 regarding an insufficiency of the available power at the one or more power delivery segments 110.

The capacity indication system 300 includes one or more output modules 312 communicably coupled with the one or more processors 306. The one or more processors 306 transmit the output signal S1 to the one or more output modules 312. Based on receipt of the output signal S1, the one or more output modules 312 indicate the insufficiency of the available power at the one or more power delivery segments 110. The one or more output modules 312 are communicably coupled with the one or more processors 306 via a wired connection or a wireless connection. The wireless connection may include, for example, Wi-Fi.

Further, in the illustrated example of FIG. 3, the one or more output modules 312 is a light indication system 314. It should be noted that multiple light indication systems 314 may be disposed at the worksite 100 proximal to the power delivery segment 110. The one or more output modules 312 display a first light to indicate the insufficiency of the available power at the one or more power delivery segments 110, a second light to indicate that the available power at the one or more power delivery segments 110 is approaching the threshold power level, or a third light to indicate that a sufficient amount of power is available at the one or more power delivery segments 110. In other words, the first light indicates an overloaded condition, the second light indicates caution as power capacity is approaching its limit, and the third light indicates that a particular work machine 102 may be connected to the power delivery segment 110 for receiving the power supply. In one example, the first light may be a red light, the second light may be an orange light, and the third light may be a green light.

In some examples, the light indication system 314 may be installed at any suitable location on the worksite 100 such that the light indication system 314 is visible to operators and lies in a line of sight of operators approaching the power delivery segment 110. In some examples, the light indication system 314 may be installed adjacent to the power delivery segment 110, or the light indication system 314 may be installed on the pole 114 (see FIG. 1) or on the stand 214 (see FIG. 2). In some examples, the light indication system 314 may be installed before a starting point of the power delivery segment 110.

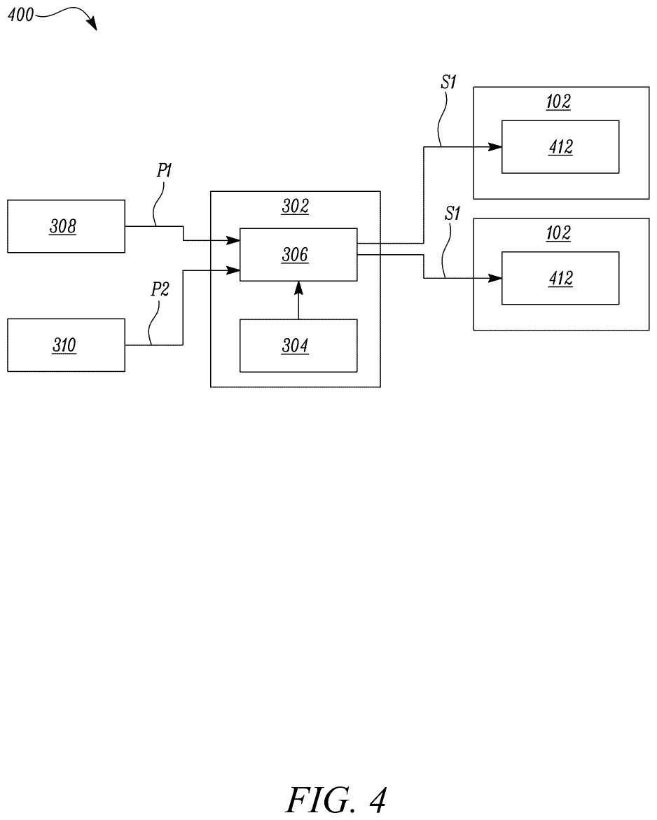

Referring to FIG. 4, a block diagram for a capacity indication system 400 is provided. The capacity indication system 400 is associated with the electric power supply system 108, 208 (see FIGS. 1 and 2). For explanatory purpose, the capacity indication system 400 is herein discussed corresponding to the electric power supply system 108. The capacity indication system 400 is substantially similar to the capacity indication system 300 explained in relation to FIG. 3, with common components referred to by the same numeral.

The capacity indication system 400 includes one or more output modules 412 communicably coupled with the one or more processors 306. The one or more output modules 412 is communicably coupled with the one or more processors 306 via a wireless connection. The one or more output modules 412 include a number of output modules 412 herein. In particular, the one or more output modules 412 includes two output modules 412 herein. Each of the one or more work machines 102 operating at the worksite 100 includes a corresponding output module 412 from the number of output modules 412. The one or more processors 306 transmit the output signal S1 to each of the number of output modules 412. Further, based on receipt of the output signal S1, each of the number of output modules 412 indicates the insufficiency of the available power at the one or more power delivery segments 110 (see FIG. 1).

The output modules 412 are display modules that may be present within each of the two work machines 102. Alternatively, the output modules 412 may be present with an operator in charge of the work machines 102, and the operator may be present outside the work machines 102. The output modules 412 may provide audio notifications, visual notifications, or a combination thereof to indicate the insufficiency of the available power at the one or more power delivery segments 110. Thus, in this example, the processors 306 are in direct communication with the output modules 412 associated with the work machines 102.

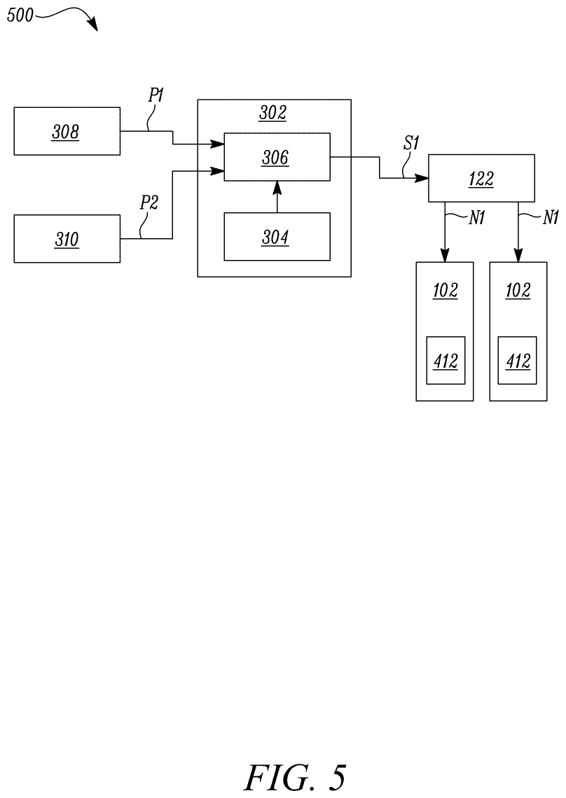

Referring to FIG. 5, a block diagram for a capacity indication system 500 is provided. The capacity indication system 500 is associated with the electric power supply system 108, 208 (see FIGS. 1 and 2). The capacity indication system 500 is substantially similar to the capacity indication system 300 explained in relation to FIG. 3, with common components referred to by the same numeral. For explanatory purpose, the capacity indication system 500 is herein discussed corresponding to the electric power supply system 108.

In the example illustrated in FIG. 5, the one or more processors 306 transmit the output signal S1 to the sitewide control system 122. The sitewide control system 122 is communicably coupled with the one or more work machines 102 operating at the worksite 100. In this example, the sitewide control system 122 is communicably coupled with the two work machines 102 operating at the worksite 100. Further, based on receipt of the output signal S1, the sitewide control system 122 transmits a notification N1 to a corresponding output module 412 of the one or more work machines 102 to indicate the insufficiency of the available power at the one or more power delivery segments 110. Thus, in the illustrated example of FIG. 5, the processors 306 are in communication with the output modules 412 associated with the work machines 102 via the sitewide control system 122.

The sitewide control system 122 may include a controller (not shown) that may receive the output signal S1 and generate the notification N1. Additionally, if the work machines 102 are remotely operated, an output module (not shown) may also be present at the back-office present at the worksite 100, without any limitations. In such examples, a personnel present at the back-office may be notified regarding the insufficiency of the available power at the one or more power delivery segments 110.

Referring to FIGS. 3, 4, and 5, in some examples, the capacity indication system 300 may include each of the output modules 312 and the output modules 412. Similarly, the capacity indication system 400, 500 may include each of the output modules 312 and the output modules 412.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### Industrial Applicability

The present disclosure is related to the capacity indication system 300, 400, 500 associated with the electric power supply system 108, 208. The electric power supply system 108, 208 includes the one or more power delivery segments 110, 210 disposed at the worksite 100. The one or more power delivery segments 110, 210 provide electric power to the predetermined number of work machines 102 operating at the worksite 100. Further, the capacity indication system 300, 400, 500 includes the controller 302. The one or more processors 306 of the controller 302 generate the output signal S1 if the available power at the one or more power delivery segments 110, 210 is lesser than the threshold power level. The output signal S1 indicates the operators of the work machines 102 regarding the insufficiency of the available power at the one or more power delivery segments 110, 210.

Overall, the capacity indication system 300, 400, 500 associated with the electric power supply system 108, 208 may assist the operators in supplying power to the respective work machine 102. The capacity indication system 300, 400, 500 may provide instructions regarding whether additional work machines 102 can be connected to the power delivery segments 110, 210. The capacity indication system 300, 400, 500 may be used with the electric power supply system 108, 208 that may include the overhead trolley line system or the dynamic energy transfer system, respectively.

Further, the calculation of the available power may be based on actual measurements or by receiving data about other work machines 102 that may be currently connected at the one or more power delivery segments 110, 210. Furthermore, the calculation may be based on actual power draws by each work machine 102 connected to the power delivery segments 110, 210 or based on the type or the number of work machines 102 connected to the power delivery segment 110, 210. Consideration of the above stated parameters while determining the available power may increase an accuracy of the capacity indication system 300, 400, 500. Further, in some examples, the processors 306 may receive each of the input signal P1, P2, which may improve accuracy of the capacity indication system 300, 400, 500.

Furthermore, in case of insufficient power to add the next work machine 102 in queue, the output signal S1 may be sent to the light indication system 314 and/or to the output modules 412 associated with the work machines 102 to alert operators regarding the insufficiency of power. The present disclosure provides a simple, convenient, and cost-effective way of alerting operators regarding the availability of power at the power delivery segment 110, 210, via the light indication system 314 and/or the output modules 412.

The capacity indication system 300, 400, 500 may prevent low voltage situations at the power delivery segment 110, 210, may reduce rejection rates at the power delivery segment 110, 210, may retain/improve a speed of supplying power supply to the work machines 102 that are already connected to the power delivery segment 110, 210, and/or prevent an outage or overload situation at the power delivery segment 110, 210, by notifying the operators when a particular power delivery segment 110, 210 has reached its maximum capacity. Further, the capacity indication system 300, 400, 500 may improve an operational efficiency at the worksite 100 by providing real-time information about the availability of power at the power delivery segment 110, 210. Furthermore, the capacity indication system 300, 400, 500 may be implemented at existing worksites. The capacity indication system 300, 400, 500 may assist the sitewide control system 122 to optimally control the deployment of the work machines 102.

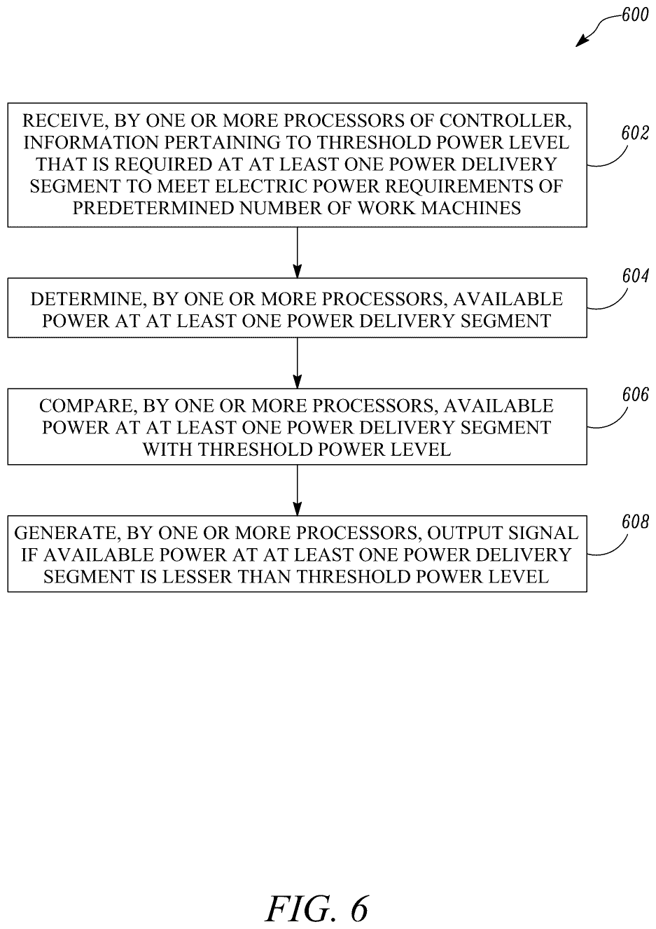

FIG. 6 is a flowchart for a method 600 of indicating capacity of the one or more power delivery segments 110, 210 of the electric power supply system 108, 208. With reference to FIGS. 1 to 6, the one or more power delivery segments 110, 210 provides electric power to the predetermined number of work machines 102 operating at the worksite 100. At a step 602, the one or more processors 306 of the controller 302 receive the information pertaining to the threshold power level that is required at the one or more power delivery segments 110, 210 to meet the electric power requirements of the predetermined number of work machines 102. The information pertaining to the threshold power level is received from the one or more memories 304 of the controller 302.

Further, at a step 604, the one or more processors 306 determine the available power at the one or more power delivery segments 110, 210. In some examples, the step 604 further includes receiving the input signal P2 from the segment controller 310 associated with the one or more power delivery segments 110, 210 to determine the available power at the one or more power delivery segments 110, 210. The one or more processors 306 are communicably coupled with the segment controller 310.

The step 604 further includes determining the available power at the one or more power delivery segments 110, 210 based on one or more of the number of work machines 102 that are connected to the one or more power delivery segments 110, 210, the amount of electric power that is being supplied to each of the number of work machines 102 that are connected to the one or more power delivery segments 110, 210, and the type of each work machine 102 from the number of work machines 102 that are connected to the one or more power delivery segments 110, 210.

At a step 606, the one or more processors 306 compare the available power at the one or more power delivery segments 110, 210 with the threshold power level. At a step 608, the one or more processors 306 generate the output signal S1 if the available power at the one or more power delivery segments 110, 210 is lesser than the threshold power level. The output signal S1 indicates the operators of the one or more work machines 102 operating at the worksite 100 regarding the insufficiency of the available power at the one or more power delivery segments 110, 210.

In some examples, the method 600 further includes a step (not shown) at which the one or more sensors 308 generate the input signal P1 pertaining to the available power at the one or more power delivery segments 110, 210. The one or more sensors 308 are disposed at the one or more power delivery segments 110, 210. The method 600 further includes a step (not shown) at which the one or more processors 306 receive the input signal P1 from the one or more sensors 308 to determine the available power at the one or more power delivery segments 110, 210. The one or more sensors 308 are communicably coupled with the one or more processors 306.

The method 600 further includes a step (not shown) at which the one or more processors 306 transmit the output signal S1 to the one or more output modules 312, 412. The one or more output modules 312, 412 are communicably coupled with the one or more processors 306. The method 600 further includes a step (not shown) at which the one or more output modules 312, 412 indicate the insufficiency of the available power at the one or more power delivery segments 110, 210 based on the receipt of the output signal S1.

Further, in one example, the one or more output modules 312 is the light indication system 314. The method 600 further includes a step (not shown) at which the light indication system 314 displays the first light to indicate the insufficiency of the available power at the one or more power delivery segments 110, 210, the second light to indicate that the available power at the one or more power delivery segments 110, 210 is approaching the threshold power level, or the third light to indicate that sufficient amount of power is available at the one or more power delivery segments 110, 210.

Further, in some examples, the one or more output modules 412 include the number of output modules 412. Each of the one or more work machines 102 operating at the worksite 100 includes the corresponding output module 412 from the plurality of output modules 412. The method 600 further includes a step (not shown) at which the one or more processors 306 transmit the output signal S1 to each of the number of output modules 412. The method 600 further includes a step (not shown) at which each of the number of output modules 412 indicate the insufficiency of the available power at the one or more power delivery segments 110, 210 based on the receipt of the output signal S1.

Further, the method 600 includes a step (not shown) at which the one or more processors 306 transmit the output signal S1 to the sitewide control system 122. The sitewide control system 122 is communicably coupled with the one or more work machines 102 operating at the worksite 100.

Further, the method 600 includes a step (not shown) at which the sitewide control system 122 transmits the notification N1 to the one or more work machines 102 to indicate the insufficiency of the available power at the one or more power delivery segments 110, 210 based on the receipt of the output signal S1.

It should be noted that the steps 602, 604, 606, 608 of the method 600 may be performed in a sequence that is different from that explained in relation to FIG. 6. Further, various steps 602, 604, 606, 608 can be performed together.

While aspects of the present disclosure have been particularly shown and described with reference to the embodiments above, it will be understood by those skilled in the art that various additional embodiments may be contemplated by the modification of the disclosed machine, systems, and methods without departing from the spirit and scope of the disclosure. Such embodiments should be understood to fall within the scope of the present disclosure as determined based upon the claims and any equivalents thereof.

What is claimed is:

1. A capacity indication system associated with an electric power supply system, the electric power supply system includes one or more power delivery segments disposed at a worksite, and the one or more power delivery segments are adapted to provide electric power to a predetermined number of work machines operating at the worksite, the capacity indication system comprising:
a controller including one or more memories and one or more processors communicably coupled to the one or more memories, wherein the one or more processors are configured to:
receive, from the one or more memories, information pertaining to a threshold power level that is required at the one or more power delivery segments to meet electric power requirements of the predetermined number of work machines;
determine an available power at the one or more power delivery segments;
compare the available power at the one or more power delivery segments with the threshold power level; and
generate an output signal if the available power at the one or more power delivery segments is lesser than the threshold power level, wherein the output signal is adapted to indicate operators of one or more work machines operating at the worksite regarding an insufficiency of the available power at the one or more power delivery segments.

2. The capacity indication system of claim 1 further comprising one or more sensors disposed at the one or more power delivery segments, wherein the one or more sensors are configured to generate an input signal pertaining to the available power at the one or more power delivery segments, and wherein the one or more processors are configured to receive the input signal from the one or more sensors to determine the available power at the one or more power delivery segments.

3. The capacity indication system of claim 2, wherein the one or more sensors includes at least one of a current sensor, a voltage sensor, and a combination thereof.

4. The capacity indication system of claim 1, wherein the one or more processors are communicably coupled with a segment controller associated with the one or more power delivery segments, and wherein the one or more processors are configured to receive an input signal from the segment controller to determine the available power at the one or more power delivery segments.

5. The capacity indication system of claim 1, wherein the one or more processors are configured to determine the available power at the one or more power delivery segments based on one or more of a number of work machines that are connected to the one or more power delivery segments, an amount of electric power that is being supplied to each of the number of work machines that are connected to the one or more power delivery segments, and a type of each work machine from the number of work machines that are connected to the one or more power delivery segments.

6. The capacity indication system of claim 1 further comprising at least one output module communicably coupled with the one or more processors, wherein the one or more processors are configured to transmit the output signal to the at least one output module, and wherein, based on receipt of the output signal, the at least one output module is configured to indicate the insufficiency of the available power at the one or more power delivery segments.

7. The capacity indication system of claim 6, wherein the at least one output module is communicably coupled with the one or more processors via a wired connection or a wireless connection.

8. The capacity indication system of claim 6, wherein the at least one output module is a light indication system, and wherein the at least one output module is configured to display any one of:
a first light to indicate the insufficiency of the available power at the one or more power delivery segments;
a second light to indicate that the available power at the one or more power delivery segments is approaching the threshold power level; and
a third light to indicate that a sufficient amount of power is available at the one or more power delivery segments.

9. The capacity indication system of claim 6, wherein the at least one output module includes a plurality of output modules, wherein each of the one or more work machines operating at the worksite includes a corresponding output module from the plurality of output modules, wherein the one or more processors are configured to transmit the output signal to each of the plurality of output modules, and wherein, based on receipt of the output signal, each of the plurality of output modules is configured to indicate the insufficiency of the available power at the one or more power delivery segments.

10. The capacity indication system of claim 1, wherein the one or more processors are configured to transmit the output signal to a sitewide control system, and wherein the sitewide control system is communicably coupled with the one or more work machines operating at the worksite.

11. The capacity indication system of claim 10, wherein, based on receipt of the output signal, the sitewide control system is configured to transmit a notification to the one or more work machines to indicate the insufficiency of the available power at the one or more power delivery segments.

12. A method of indicating capacity of one or more power delivery segments of an electric power supply system, the one or more power delivery segments are adapted to provide electric power to a predetermined number of work machines operating at a worksite, the method comprising:
receiving, by one or more processors of a controller, information pertaining to a threshold power level that is required at the one or more power delivery segments to meet electric power requirements of the predetermined number of work machines, wherein the information pertaining to the threshold power level is received from one or more memories of the controller;
determining, by the one or more processors, an available power at the one or more power delivery segments;
comparing, by the one or more processors, the available power at the one or more power delivery segments with the threshold power level; and
generating, by the one or more processors, an output signal if the available power at the one or more power delivery segments is lesser than the threshold power level, wherein the output signal is adapted to indicate operators of one or more work machines operating at the worksite regarding an insufficiency of the available power at the one or more power delivery segments.

13. The method of claim 12 further comprising:
generating, by one or more sensors, an input signal pertaining to the available power at the one or more power delivery segments, wherein the one or more sensors are disposed at the one or more power delivery segments; and
receiving, by the one or more processors, the input signal from the one or more sensors to determine the available power at the one or more power delivery segments, wherein the one or more sensors are communicably coupled with the one or more processors.

14. The method of claim 12, wherein the step of determining, by the one or more processors, the available power at the one or more power delivery segments, further includes receiving, by the one or more processors, an input signal from a segment controller associated with the one or more power delivery segments to determine the available power at the one or more power delivery segments, wherein the one or more processors are communicably coupled with the segment controller.

15. The method of claim 12, wherein the step of determining, by the one or more processors, the available power at the one or more power delivery segments further includes determining the available power based on one or more of a number of work machines that are connected to the one or more power delivery segments, an amount of electric power that is being supplied to each of the number of work machines that are connected to the one or more power delivery segments, and a type of each work machine from the number of work machines that are connected to the one or more power delivery segments.

16. The method of claim 12 further comprising:
transmitting, by the one or more processors, the output signal to at least one output module, wherein the at least one output module is communicably coupled with the one or more processors; and
indicating, by the at least one output module, the insufficiency of the available power at the one or more power delivery segments based on receipt of the output signal.

17. The method of claim 16, wherein the at least one output module is a light indication system, the method further comprising displaying, via the light indication system, any one of:
a first light to indicate the insufficiency of the available power at the one or more power delivery segments;
a second light to indicate that the available power at the one or more power delivery segments is approaching the threshold power level; and
a third light to indicate that a sufficient amount of power is available at the one or more power delivery segments.

18. The method of claim 16, wherein the at least one output module includes a plurality of output modules, and wherein each of the one or more work machines operating at the worksite includes a corresponding output module from the plurality of output modules, the method further comprising:
transmitting, by the one or more processors, the output signal to each of the plurality of output modules; and
indicating, by each of the plurality of output modules, the insufficiency of the available power at the one or more power delivery segments based on receipt of the output signal.

19. The method of claim 12 further comprising transmitting, by the one or more processors, the output signal to a sitewide control system, wherein the sitewide control system is communicably coupled with the one or more work machines operating at the worksite.

20. The method of claim 19 further comprising transmitting, by the sitewide control system, a notification to the one or more work machines to indicate the insufficiency of the available power at the one or more power delivery segments based on receipt of the output signal.
